(19) United States
(12) Patent Application Publication
(10) Pub. No.: US 2004/0241549 A1
(43) Pub. Date: Dec. 2, 2004

(54) Negative electrode for rechargeable lithium battery and rechargeable lithium battery comprising same

(75) Inventors: Chung-Kun Cho, Suwon-city (KR); Duck-Chul Hwang, Suwon-city (KR); Seung-Sik Hwang, Seongnam-city (KR); Sang-Mock Lee, Suwon-city (KR)

Correspondence Address: STAAS & HALSEY LLP, SUITE 700, 1201 NEW YORK AVENUE, N.W., WASHINGTON, DC, 20005, US

(73) Assignee: SAMSUNG SDI CO., LTD., Suwon-si (KR)

(21) Appl. No.: 10/776,229

(22) Filed: Feb. 12, 2004

(30) Foreign Application Priority Data
May 27, 2003 (KR) 2003-33819

(51) Int. Cl. H01M 2/16; H01M 4/66; H01M 4/40

(52) U.S. Cl. 429/246; 429/245; 429/231.95

(57) ABSTRACT

A negative electrode includes a first polymer layer, a second polymer layer on the first polymer layer, a metal layer on the second polymer layer and a negative active material layer on the metal layer.

### CROSS-REFERENCE TO RELATED APPLICATIONS

This application is based on application 2003-33819 filed in the Korean Intellectual Property Office on May 27, 2003, the disclosure of which is incorporated hereinto by reference.

### BACKGROUND OF THE INVENTION

1. Field of the Invention

The present invention relates to a negative electrode for a rechargeable lithium battery and a rechargeable lithium battery comprising the same, and more particularly, to a negative electrode for a rechargeable lithium battery exhibiting an improved cycle life characteristic and a rechargeable lithium battery comprising the same.

2. Description of the Related Art

The continued development of portable electronic devices has led to a corresponding increase in the demand for rechargeable batteries having both a lighter weight and a higher capacity. To satisfy such demands, the most promising approaches are rechargeable lithium batteries such as lithium-sulfur batteries and lithium ion batteries. Among these rechargeable lithium batteries, lithium-sulfur batteries have become very attractive because they have a higher capacity than lithium ion batteries.

Lithium-sulfur batteries use sulfur-based compounds with sulfur-sulfur bonds as a positive active material, and a lithium metal or a carbon-based compound as a negative active material. The carbon-based compound is one that reversibly intercalates or deintercalates metal ions, such as lithium ions. Upon discharging (i.e., electrochemical reduction), the sulfur-sulfur bonds are cleaved, resulting in a decrease in the oxidation number of the sulfur (S). Upon recharging (i.e., electrochemical oxidation), the sulfur-sulfur bonds are re-formed, resulting in an increase in the oxidation number of the S. The electrical energy is stored in the battery as chemical energy during charging, and is converted back to electrical energy during discharging.

The lighter and higher energy density of lithium metal makes it widely used as a negative active material for a lithium-sulfur battery. The lithium metal acts as the active material as well as a current collector so it may be used without an additional current collector in the lithium-sulfur battery. However, for consideration of cycle life characteristics, a metal-deposited polymer current collector is suitably used. The polymer may be polyethyleneterephthalate, polypropylene, polyethylene, polyvinylchloride, polyolefin, or polyimide, and the metal may be copper. The metal is utilized to prevent a reaction between the lithium metal and the polymer, which results in the blackening or modification of the polymer so that the properties of the polymer deteriorate. To obtain the above effect, the metal should be deposited on the polymer until the thickness reaches about 3000 Å, because the metal with a thickness of less than about 3000 Å has micropores which allow lithium ions to move therethrough such that the reaction between the lithium metal and the polymer film is not completely prevented, thus causing a decrease in the cycle life characteristic. However, the high melting point of copper necessitates deposition to the above described thickness at high temperatures for an extended period of time, which leads to deterioration of the properties of the polymer film and to wrinkling of the polymer film.

### SUMMARY OF THE INVENTION

It is an aspect of the present invention to provide a negative electrode for a rechargeable lithium battery which effectively and completely prevents a reaction between a polymer film and a negative active material.

It is another aspect to provide a negative electrode for a rechargeable lithium battery with a thin metal layer and without deterioration of a polymer film.

It is still another aspect to provide a rechargeable lithium battery including the negative electrode.

These and/or other aspects may be achieved by a negative electrode for a rechargeable lithium battery including a first polymer layer, a second polymer layer on the first polymer layer, a metal layer on the second polymer layer; and a negative active material layer on the metal layer.

To achieve these and/or other aspects, the present invention provides a rechargeable lithium battery including the negative electrode, a positive electrode including a positive active material, and an electrolyte.

Additional aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the preferred embodiments, taken in conjunction with the accompanying drawings of which:

FIG. 1 is a side cross-sectional view showing a negative electrode for a rechargeable lithium battery according to an embodiment of the present invention;

FIG. 2 is a side cross-sectional view showing a negative electrode for a rechargeable lithium battery according to another embodiment of the present invention;

FIG. 3 is a photograph of a surface of a negative active material layer of a negative electrode according to Example 1 of the present invention;

FIG. 4 is a photograph of a face of a current collector layer of a negative electrode according to Example 1 of the present invention;

FIG. 5 is a photograph of a surface of a negative active material layer of a negative electrode according to Example 1 of the present invention; and

FIG. 6 is a photograph of a face of a current collector layer of a negative electrode according to Example 1 of the present invention.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

The present invention relates to a negative electrode for a rechargeable lithium battery. The negative electrode includes a protection layer to protect a polymer layer acting as a current collector. The protection layer prevents a reaction between a negative active material and the current collector that is due to a high reactivity of the negative active material at high temperatures.

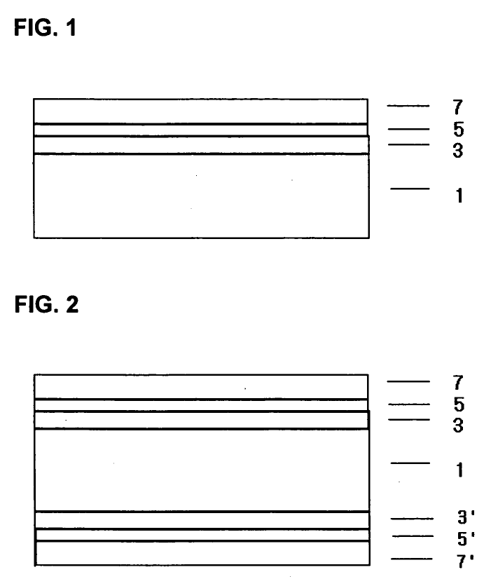

One embodiment of the negative electrode of the present invention includes a first polymer layer 1, a second polymer layer 3, a metal layer 5, and a negative active material layer 7. Another embodiment of the negative electrode includes a first polymer layer 1, two second polymer layers 3, 3′ one on each side of the first polymer layer, metal layers 5,5′ on the second polymer layer, and negative active material layers 7, 7′ on the metal layers. The negative electrode shown in FIG. 2 is similar to that shown in FIG. 1, except that the second layer, the metal layer, and the negative active material layer are each presented in duplicate. Thus, in the specification, the detailed description of the negative electrode shown in FIG. 2 will be not described.

The second polymer layer 3 is positioned between the first polymer layer 1 and the metal layer 5 to prevent the movement of any unreacted monomer which may be present in the first polymer layer through holes in the metal layer 5 which causes the reaction between the unreacted monomer and the negative active material. The second polymer layer more effectively prevents reaction between the first polymer layer 1 and the negative active material layer when compared with utilizing only the metal layer 5. The second polymer layer allows the thickness of the metal layer 5 to be decreased, which leads to lowering of the deposition temperature and reducing the deposition time, thus maintaining the flat polymer film.

The thickness of the second polymer layer is preferably 0.01 to 10 μm, more typically 0.02 to 7.5 μm, and most typically 0.03 to 5 μm. A thickness of less than 0.01 μm does not completely prevent the reaction between the unreacted monomer and the negative active material. A thickness of more than 10 μm results in a negative active material layer that is too thin, decreasing energy density.

The second polymer layer 3 includes any material as long as it forms a dense layer and is stable during metal layer preparation, especially with respect to high temperatures and high pressure. Examples thereof are a silicon-included compound, polyalkylene oxide, polyolefin, polydiene, polyfluorocarbon, a mixture thereof, and a copolymer thereof. Generally, the silicon-included compound may be utilized. The silicon-included compound is represented by formula 1.

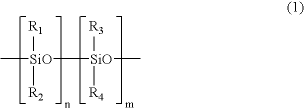

where R₁, R₂, R₃, and R₄ are identically or independently selected from C₁-C₁₈ linear alkyls, or a branched alkyl, cyclic alkyl, alkenyl, aryl, aralkyl, halogenated alkyl, halogenated aryl, halogenated aralkyl, phenyl, mercaptan, methacrylate, acrylate, epoxy, or vinyl ether; and n and m are the same or different integers of 1 to 100,000.

The silicon-included compound is a thermosetting resin which does not melt and flow at high temperatures. In addition, during thermosetting, a Si—O—Si bond is generated in the silicon-included compound so that the compound is more impervious to heat. A higher thermosetting temperature decreases the thermosetting time, but the temperature is suitably controlled to temperature ranges in which modification of the polymer film does not occur.

The second polymer layer may be formed on the first layer by a coating process such as knife coating, direct roll coating, reverse roll coating, gravure roll coating, gap coating, spray coating, or slot die coating, and then drying it, e.g., by hot-air drying. Slot die coating or gravure roll coating are typically used because they form the protectant as a thin film. Alternatively, the second polymer layer on the first polymer layer may be available through a commercial purchase.

The first polymer layer may be a polymer film which supports the negative active material and does not participate in the battery reaction, and typically the polymer film is deposited with a metal. The examples of the polymer include, but are not limited to polypropylene, polyethylene, polyethylene terephthalate, polyamide, polyimide, polyolefin, polyester, polyacetal, polycarbonate, polysulfone, polyvinylchloride, poly vinyl alcohol, or poly vinyl acetate.

The thickness of the first polymer layer is preferably 1 to 200 μm, more typically 2 to 100 μm, and most typically 3 to 50 μm. If the thickness of the first polymer layer is less than 1 μm, it is difficult to handle. If the thickness of the first polymer layer is more than 200 μm, it is difficult to roll because of the higher tension. Generally, an electrode that is considerably longer than an eventually desired size is produced and stored in a rolled state.

The metal layer 5 on the first polymer layer 3 prevents direct contact between the first polymer layer 1 and the negative active material layer 7. The metal layer generally has a thickness of 1 to 10,000 μm, more generally 5 to 5,000 μm, and most generally 10 to 1000 μm. If the thickness of the metal layer 5 is less than 1 μm, the effect by the metal layer 5 is not achieved. If the thickness of the metal layer 5 is more than 10,000 μm, the energy density of the battery is reduced.

The metal layer 3 generally includes a metal selected from Ni, Ti, Cu, Ag, Au, Pt, Fe, Co, Cr, W or Mo, or a metal being capable of forming an alloy with lithium, such as Al, Mg, K, Na, Ca, Sr, Ba, Si, Ge, Sb, Pb, In, or Zn.

The negative active material layer 7 on the metal layer 3 generally has a thickness of 1 to 100 μm, more generally 2 to 80 μm, and most generally 3 to 50 μm. If the thickness of the negative active material layer 7 is less than 1 μm, the capacity of the battery is reduced. If the thickness of the negative active material layer 7 is more than 100 μm, the energy density is reduced.

The negative active material layer 7 includes a negative active material selected from a material that reacts with lithium ions to form a lithium-containing compound, a lithium metal, or a lithium alloy.

Examples of the material that reacts with lithium ions to form a lithium-containing compound include, but are not limited to, tin oxide (SnO₂), titanium nitrate or Si. The lithium alloys include an alloy of lithium and a metal selected from Na, K, Rb, Cs, Fr, Be, Mg, Ca, Sr, Ba, Ra, Al, or Sn.

A rechargeable battery with the negative electrode of the present invention also includes a positive electrode and an electrolyte. The positive electrode includes a positive active material, which includes elemental sulfur (S₈), a sulfur-based compound, or a mixture thereof. The sulfur-based compound is selected from an organic-sulfur compound or a carbon-sulfur polymer ((C₂Sₓ)ₙ: x=2.5 to 50, n≧2). Alternatively, the positive active material may include lithiated metal oxides in which lithium intercalation reversibly occurs. That is, all positive active materials used in rechargeable lithium batteries may be used in the present invention, as is well understood in the related art.

The electrolyte includes an electrolytic salt and an organic solvent.

The organic solvent may be a sole solvent or a mixed organic solvent with at least two components. The mixed organic solvent includes at least two groups selected from a weak polar solvent group, a strong polar solvent group, or a lithium protection group.

The term “weak polar solvent,” as used herein, is defined as a solvent that is capable of dissolving elemental sulfur and that has a dielectric coefficient that is less than 15. The weak polar solvent is selected from aryl compounds, bicyclic ether, or acyclic carbonate compounds. The term “strong polar solvent,” as used herein, is defined as a solvent that is capable of dissolving lithium polysulfide and that has a dielectric coefficient that is greater than 15. The strong polar solvent is selected from bicyclic carbonate compounds, sulfoxide compounds, lactone compounds, ketone compounds, ester compounds, sulfate compounds, or sulfite compounds. The term “lithium protection solvent,” as used herein, is defined as a solvent that forms a good protection layer, i.e., a stable solid-electrolyte interface (SEI) layer, on a lithium surface, and which shows a cyclic efficiency of at least 50%. The lithium protection solvent is selected from saturated ether compounds, unsaturated ether compounds, or heterocyclic compounds including N, O, and S.

Examples of the weak polar solvents include xylene, dimethoxyethane, 2-methyltetrahydrofuran, diethyl carbonate, dimethyl carbonate, toluene, dimethyl ether, diethyl ether, diglym, or tetraglyme.

Examples of the strong polar solvents include hexamethyl phosphoric triamide, γ-butyrolactone, acetonitrile, ethylene carbonate, propylene carbonate, N-methylpyrrolidone, 3-methyl-2-oxazolidone, dimethyl formamide, sulfolane, dimethyl acetamide, dimethyl sulfoxide, dimethyl sulfate, ethylene glycol diacetate, dimethyl sulfite, or ethylene glycol sulfite.

Examples of the lithium protection solvents include tetrahydrofuran, 1,3-dioxolane, 3,5-dimethylisoxazole, 2,5-dimethyl furan, furan, 2-methyl furan, 1,4-oxane, and 4-methyldioxolane.

Examples of electrolyte salts include lithium trifluoromethane sulfonimide, lithium triflate, lithium perchlorate, LiPF₆, LiBF₄, tetraalkylammonium salts such as tetrabutylammonium tetrafluoroborate (TBABF₄), liquid state salts at room temperature, e.g., an imidazolium salt such as 1-ethyl-3-methylimidazolium Bis-(perfluoroethyl sulfonyl) imide (EMIBeti), or a combination thereof.

The following examples illustrate the present invention in further detail, but it is understood that the present invention is not limited by these examples.

### EXAMPLE 1

A silicon resin composition (including 22.5 wt % of Syl-off 7900 (trade-mark DOW CORNING CORPORATION), 2.5 wt % of Syl-off 7922 (trade-mark DOW CORNING CORPORATION), and 75 wt % of water) was coated on a 25 μm thick polyethylene terephthalate film by a mayer bar coating procedure, and then dried at a temperature of 180° C. in an oven for 2 minutes, to produce a polyethylene terephthalate film coated with a 0.3 μm thick second polymer layer.

Copper was deposited on the second polymer layer coated on the polyethylene terephthalate film. At this time, the thickness of the copper layer was controlled to 3000 Å. Thereafter, a lithium metal was deposited on the copper layer to a thickness of 1 μm to produce a negative electrode.

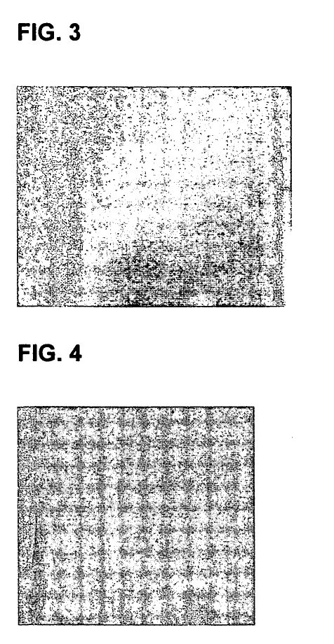

The resulting negative electrode was allowed to stand at 100° C. for 3 hours under vacuum to determine the effect of the second polymer layer, which is the layer to prevent reaction between the lithium metal and the polyethylene terephthalate film at a high temperature. The temperature was set to 100° C. to simulate the large scale electrode production environment at high pressure. Photographs of the surface of the lithium metal and the side of the polyethylene terephthalate film are shown in FIGS. 3 and 4, respectively. As shown in FIGS. 3 and 4, the surface of the lithium metal and the side of the polyethylene terephthalate film were not discolored. These results indicate that the silicon resin second polymer layer prevents reaction between the lithium metal and the polyethylene terephthalate film.

### EXAMPLE 2

A negative electrode was produced and evaluated by the same procedure as in Example 1, except that a copper layer of a thickness of 1000 Å was deposited on the 25 μm thick second polymer layer coated with the polyethylene terephthalate film. The surface of the lithium metal and the side of the polyethylene terephthalate film were not discolored.

### COMPARATIVE EXAMPLE 1

Copper was deposited directly on a 25 μm thick polyethylene terephthalate film. At this time, the thickness of the copper layer was controlled to 1500 Å. Thereafter, a lithium metal was deposited on the copper layer to a thickness of 1 μm to produce a negative electrode.

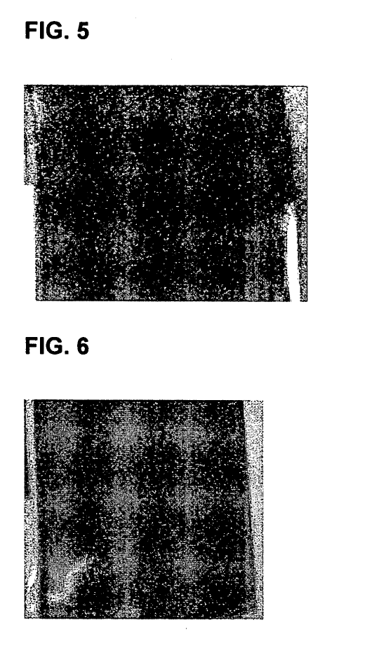

The resulting negative electrode was allowed to stand at 100° C. for 3 hours under a vacuum to identify the effect of a lack of a second polymer layer. Photographs of the surface of the lithium metal and the side of the polyethylene terephthalate film are shown in FIGS. 5 and 6, respectively. As shown in FIGS. 5 and 6, the surface of the lithium metal was partially red-discolored, and the side of the polyethylene terephthalate film was blackened. These results indicate that a reaction between the lithium metal and the polyethylene terephthalate film occurred because of lithium ions moving through the copper with a thickness of 1500 Å.

### COMPARATIVE EXAMPLE 2

A negative electrode was produced and evaluated by the same procedure as in Comparative Example 1, except that a copper layer with a thickness of 2000 Å was deposited on the non-coated 25 μm thick polyethylene terephthalate film.

### COMPARATIVE EXAMPLE 3

A negative electrode was produced and evaluated by the same procedure as in Comparative Example 1, except that a copper layer with a thickness of 3000 Å was deposited on the non-coated 25 μm thick polyethylene terephthalate film.

Changes in color of the surface of the lithium metal layer and the side of the polyethylene terephthalate (PET) film of the negative electrodes according to Examples 1 and 2 and Comparative Examples 1 to 3, after they were allowed to stand at 100° C. for 3 hours, are presented in Table 1.

TABLE 1

| | | Change in color* | |
|---|---|---|---|
| | | Surface of | |
| | | the lithium | Side of the |
| | | metal layer | PET film |
| Comparative | PET(25 μm)/Cu(1,500□)/ | X | X |
| Example 1 | Li(1 μm) | | |
| Comparative | PET(25 μm)/Cu(2,000□)/ | ◯ | Δ |
| Example 2 | Li(1 μm) | | |
| Comparative | PET(25 μm)/Cu(3,000□)/ | ε | ◯ |
| Example 3 | Li(1 μm) | | |
| Example 1 | PET(25 μm)/silicon(0.3 μm), | ε | ε |
| | Cu(3,500□)/Li(1 μm) | | |
| Example 2 | PET(25 μm)/silicon(0.3 μm), | ε | ε |
| | Cu(1,000□)/Li(1 μm) | | |

*Degree of change in color: worst (X), bad (Δ), good (◯), best (ε)

As shown in Table 1, the negative electrodes according to Example 1, and Example 2 that had a thinner than conventional copper layer, were not discolored, but that according to Comparative Example 3, showed discoloration of the side of the PET film. In addition, those according to Comparative Examples 1 and 2 with thinner than conventional copper layers were discolored on the both the surface of the lithium metal layer and the side of the PET film.

Using the negative electrode according to Example 1 and Comparative Example 1, lithium-sulfur pouch-type cells were fabricated by the general procedure. Positive electrode were produced by mixing 60 wt % of an elemental sulfur (S₈) positive active material, 20 wt % of a carbon conductive agent, and 20 wt % of a polyvinylpyrrolidone binder in an isopropyl alcohol solvent to prepare a positive active material slurry, and coating the slurry on carbon-coated Al current collectors followed by drying at room temperature for 2 hours and further drying the same at 50° C. for 12 hours. The size of the positive electrodes was 25 mm×50 mm. The cells were test cells with a higher capacity than a coin cell. As an electrolyte, 1 M LiN(SO₂CF₃)₂ in a mixed solvent of dimethoxy ethane and 1,3-dioxolane (80:20 volume ratio) was used.

The cells were charged at 0.2 C and discharged at 0.5 C, and the capacity and the cycle life characteristic were measured. The results are shown in Table 2.

TABLE 2

| | Capacity at 1st | Capacity at 20^{th} | Cycle life at 20th |
|---|---|---|---|
| | cycle (mAh/g) | cycle (mAh/g) | cycles (%) |
| Comparative | 830 | 736 | 88.7 |
| Example 1 | | | |
| Example 1 | 834 | 826 | 99.0 |

It is evident from Table 2 that the cell according to Example 1 had a capacity corresponding to that of Comparative Example 1, but it had a significantly improved cycle life in comparison.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A negative electrode for a rechargeable lithium battery comprising:
a first polymer layer;
a second polymer layer on the first polymer layer;
a metal layer on the second polymer layer; and
a negative active material layer on the metal layer.

2. The negative electrode of claim 1, wherein the second polymer layer is formed by a coating process of one of: knife coating, direct roll coating, reverse roll coating, gravure roll coating, gap coating, spray coating, and slot die coating.

3. The negative electrode of claim 1, wherein the second polymer layer has a thickness of 0.01 to 10 μm.

4. The negative electrode of claim 2, wherein the second polymer layer has a thickness of 0.02 to 7.5 μm.

5. The negative electrode of claim 3, wherein the second polymer layer has a thickness of 0.03 to 5 μm.

6. The negative electrode of claim 1, wherein the second polymer layer comprises a material selected from the group consisting of a silicon-included compound, polyalkylene oxide, polyolefin, polydiene, polyfluorocarbon, a mixture thereof, and a copolymer thereof.

7. The negative electrode of claim 5, wherein the silicon-included compound is represented by formula 1: 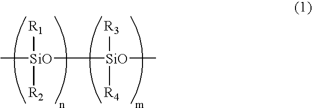
where R₁, R₂, R₃, and R₄ are identically or independently selected from C₁-C₁₈ linear alkyls, or a branched alkyl, cyclic alkyl, alkenyl, aryl, aralkyl, halogenated alkyl, halogenated aryl, halogenated aralkyl, phenyl, mercaptan, methacrylate, acrylate, epoxy, or vinyl ether; and
n and m are the same or different integers of 1 to 100,000.

8. The negative electrode of claim 1, wherein the first polymer layer is selected from the group consisting of polypropylene, polyethylene, polyethylene terephthalate, polyamide, polyimide, polyolefin, polyester, polyacetal, polycarbonate, polysulfone, polyvinylchloride, ethylene vinyl alcohol, and ethylene vinyl acetate.

9. The negative electrode of claim 1, wherein the first polymer layer has a thickness of 1 to 200 μm.

10. The negative electrode of claim 8, wherein the first polymer layer has a thickness of 2 to 100 μm.

11. The negative electrode of claim 9, wherein the first polymer layer has a thickness of 3 to 50 μm.

12. The negative electrode of claim 1., wherein the metal layer has a thickness of 1 to 10,000 μm.

13. The negative electrode of claim 11, wherein the metal layer has a thickness of 5 to 5000 μm.

14. The negative electrode of claim 12, wherein the metal layer has a thickness of 10 to 1000 μm.

15. The negative electrode of claim 1, wherein the metal layer comprises a metal selected from the group consisting of Ni, Ti, Cu, Ag, Au, Pt, Fe, Co, Cr, W, and Mo.

16. The negative electrode of claim 1, wherein the metal layer comprises a metal being capable of forming an alloy with lithium.

17. The negative electrode of claim 15, wherein the metal is selected from the group consisting of Al, Mg, K, Na, Ca, Sr, Ba, Si, Ge, Sb, Pb, In, and Zn.

18. The negative electrode of claim 1, wherein the negative active material layer has a thickness of 1 to 100 μm.

19. The negative electrode of claim 17, wherein the negative active material layer has a thickness of 2 to 80 μm.

20. The negative electrode of claim 18, wherein the negative active material layer has a thickness of 3 to 50 μm.

21. The negative electrode of claim 1, wherein the negative electrode is used in a lithium-sulfur battery.

22. The negative electrode of claim 1, wherein the negative electrode further comprises another second polymer layer, metal layer and negative active material layer sequentially formed on the side of the first polymer layer that is opposite to the second polymer layer.
